(19) United States
(12) Patent Application Publication
(10) Pub. No.: US 2026/0157364 A1
(43) Pub. Date: Jun. 11, 2026

(54) PORTABLE MULTIROLE ORGAN PERFUSION APPARATUS

(71) Applicants: BioMedInnovations, LLC, Winston-Salem, NC (US); Duke University, Durham, NC (US)

(72) Inventors: Tony Arndt, Denver, NC (US); Nader Abraham, Durham, NC (US); Charles Herman Aardema, Jr., Bassett, VA (US); Andrew Barbas, Chapel Hill, NC (US)

(21) Appl. No.: 19/538,091

(22) Filed: Feb. 12, 2026

Related U.S. Application Data
(62) Division of application No. 17/871,198, filed on Jul. 22, 2022, now abandoned.
(60) Provisional application No. 63/224,578, filed on Jul. 22, 2021.

(51) Int. Cl. A01N 1/143; A01N 1/122; A01N 1/16

(52) U.S. Cl. CPC A01N 1/143; A01N 1/122; A01N 1/16

(57) ABSTRACT

An apparatus for perfusing an organ includes: an organ chamber configured to provide physical protection to an organ; at least one fluid flow loop from an outlet connection of the organ chamber, through an oxygenator, through a pump, and to an inlet connection of the organ chamber; and a dialysis circuit, including a dialysis filter, a circulation pump, a replenishment pump, a dialysate reservoir, and a waste reservoir. The dialysis circuit includes: a first flowpath from a bleed point in the fluid flow loop, through the circulation pump, the dialysis filter, and to the perfusate reservoir; a second flowpath from the dialysate reservoir, through the replenishment pump, and to the perfusate reservoir; and a third flowpath from the dialysis filter, through the replenishment pump, and to the waste reservoir; and a container enclosing the components of the apparatus, wherein the apparatus is portable.

### BACKGROUND

This invention relates generally to medical equipment and more specifically to organ perfusion equipment.

Organs are procured from a donor and then transported for implantation into a recipient. Current methods are not able to maintain the viability of the organ for very long. This makes it difficult to match available organs with appropriate recipients.

### BRIEF DESCRIPTION OF THE INVENTION

This problem is addressed by a portable multirole organ perfusion apparatus, capable of preserving different types of grafts by adapting to each organ's vascular flow requirements via closed-loop pressure and flow feedback mechanisms.

### BRIEF DESCRIPTION OF THE DRAWINGS

The invention may be best understood by reference to the following description taken in conjunction with the accompanying drawing figures in which:

The single FIGURE is a schematic diagram of an exemplary organ support apparatus.

### DETAILED DESCRIPTION OF THE INVENTION

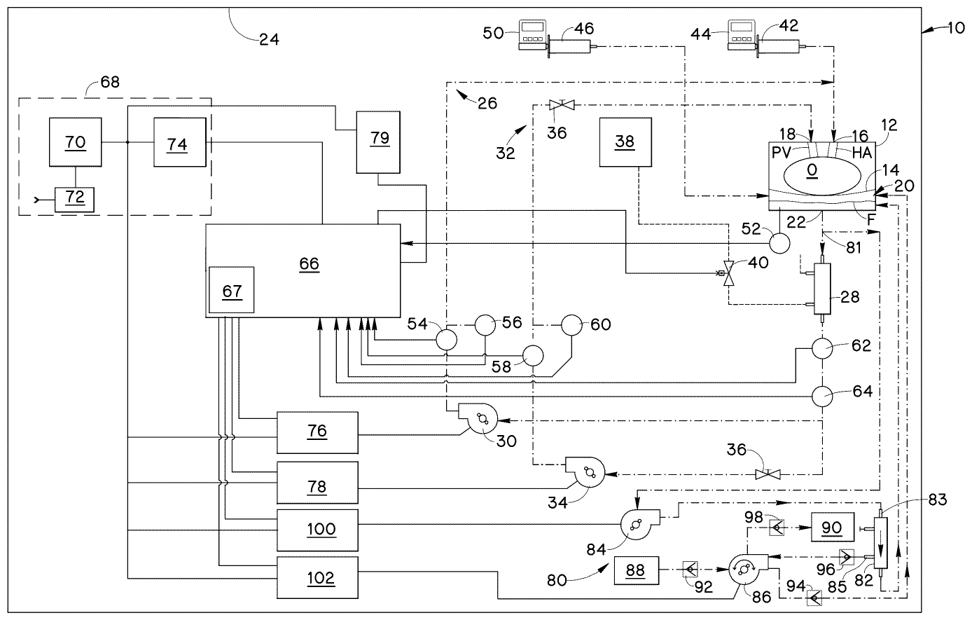

Referring to the drawings wherein identical reference numerals denote the same elements throughout the various views, FIG. 1 depicts an exemplary portable perfusion apparatus 10 suitable for circulating a perfusion fluid of specified composition through an organ “O” contained in an enclosure, referred to herein as an “organ chamber” 12. This process may be referred to as “perfusing the organ”. The organ chamber 12 provides physical protection to the organ O. It may be constructed from sterilizable material such as medical-grade plastic. In the illustrated example, the organ chamber 12 is provided internally with a flexible mesh sling 14 which supports the organ O above the operating level of perfusion fluid “F” in the organ chamber 12.

The drawings are presented in single-line format, with the single lines connecting discrete elements of the apparatus representing functional connections such as wires, tubes, pipes, or conduits. Dashed lines indicate perfusion fluid flows, dotted lines indicate gas flows (e.g., oxygen), and solid lines indicate electrical connections (e.g., power or data).

One or more fluid connections cross the boundary of the organ chamber 12 and are coupled to the organ O. In the illustrated example, the organ O is a liver. A first inlet connection 16 joins the hepatic artery “HA” of the liver, a second inlet connection 18 joins the portal vein “PV” of the liver. Fluid leaving the organ O drains into a perfusate reservoir 20 of the organ chamber 12 below the organ O. An outlet connection 22 communicates with the perfusate reservoir 20.

The illustrated example is explained in the context of providing support for a liver. As a portable multirole organ perfusion apparatus, it will be understood that the principles of the present invention are broadly applicable to the perfusion of many types of organs.

While not shown, it is possible to provide a waste storage container which receives a fluid flow of waste product or secretion from the organ (e.g., urine, bile, ileal effluent).

The perfusion fluid F is generally an acellular composition which is capable of some degree of oxygen transport. It may be, for example, an organ preservative, or other therapeutic fluid containing complex molecules.

The apparatus 10 is “portable”, defined as having weight and volume permitting it to be easily moved by an average adult human without the use of lifting equipment. In one example, the apparatus 10 may have a weight of approximately 32 kg. All of the components of the apparatus 10 may be placed in a container depicted schematically at 24, similar to a conventional tool box or equipment storage container. Generally, the container may have a maximum volume of approximately 80 L (2.83 cubic feet).

The apparatus 10 includes one or more fluid flowpaths. In the illustrated example, a first loop 26 (also referred to as a fluid flow loop) is defined from the outlet connection 22, through an oxygenator 28, through a first pump 30, and to the first inlet connection 16 of the organ chamber 12.

A second loop 32 (also referred to as a fluid flow loop) is defined from the outlet connection 22, through the oxygenator 28, through a second pump 34, back to the second inlet connection 18 of the organ chamber 12. Means are provided for isolating the second loop 32 when not in use. In the illustrated example, shutoff valves 36 are provided. These may be manually operated or remotely operated.

The pumps 30, 34 may be of any type which can provide the required flow rate and pressure of the perfusion fluid. In the illustrated example, the pumps 30, 34 are peristaltic pumps (also commonly referred to as roller pumps), each being driven by its own electric motor.

The oxygenator 28 is operable to receive gaseous oxygen and introduce it into the perfusion fluid. Suitable oxygenators are commercially available.

The fluid flowpaths are defined by plastic tubing or another suitable type of conduit. The flowpaths may be arranged such that all fluid-contacting elements can be removed from the apparatus 10 without having to sterilize the apparatus 10, e.g., in at least some variations the organ chamber 12, oxygenator 28, and associated plastic tubes, collectively defining a “tubing set” , could be removed and replaced as an assembly. By keeping one or more replacement tubing sets in ready storage, this provides the ability to remove one organ O from the apparatus 10 and quickly prepare the apparatus for another organ O. The removed tubing set could be discarded (i.e. “disposable tubing set”), or dismantled, saving selected components of the tubing set (e.g. sensor) for sterilization and reuse, or the complete tubing set could be sterilized and reused. If the complete tubing set is reused, it must be made of materials that are compatible with the selected sterilization process.

The apparatus 10 includes an oxygen supply 38 coupled to the oxygenator 28. Potential sources of oxygen supply include bottled oxygen (e.g., pure oxygen or composite gas mixtures) and oxygen concentrators. In the illustrated example, the oxygen supply 38 is an oxygen concentrator which operates by taking in ambient air (approximately 21% oxygen by volume) and removing nitrogen, producing an output gas stream that is mostly oxygen. Compared to bottled oxygen, a concentrator is safer and more convenient, as it does not include high-pressure components and it can operate as long as electrical power is available. Suitable oxygen concentrators are commercially available.

A remote-operated oxygen flow valve 40 is provided in the line between the oxygen supply 38 and the oxygenator 28.

Means may be provided for introducing additives to the perfusion fluid, including but not limited to vasodilator compounds and medications. In the illustrated example, a first syringe 42 loaded with an additive is connected in flow communication with the first fluid loop. The first syringe 42 is coupled to an electromechanical first syringe driver 44.

In the illustrated example, a second syringe 46 loaded with an additive is connected in flow communication with the perfusate reservoir 20. The second syringe 46 is coupled to an electromechanical second syringe driver 50.

The apparatus 10 includes several sensors for monitoring the perfusion process.

A temperature sensor 52 is disposed in close proximity to the organ chamber 12. It is operable to sense a temperature of the perfusion fluid F within the organ chamber 12 and produce a signal representative thereof. The signal may be used to produce a temperature indication in desired units.

A first flowrate sensor 54 is disposed downstream of the first pump 30. It is operable to sense a flowrate (e.g., volume flowrate) of the perfusion fluid and produce a signal representative thereof.

A first pressure sensor 56 is disposed downstream of the first pump 30. It is operable to sense a pressure of the perfusion fluid and produce a signal representative thereof.

A second flowrate sensor 58 downstream of the second pump 34. It is operable to sense a flowrate (e.g., volume flowrate) of the perfusion fluid and produce a signal representative thereof.

A second pressure sensor 60 is disposed downstream of the second pump 34. It is operable to sense a pressure of the perfusion fluid and produce a signal representative thereof.

An oxygen sensor 62 is disposed downstream of the oxygenator 28. It is operable to sense a partial pressure of oxygen in the perfusion fluid and produce a signal representative thereof.

A carbon dioxide sensor 64 is disposed downstream of the oxygenator 28. It is operable to sense a partial pressure of carbon dioxide in the perfusion fluid and produce a signal representative thereof.

A main controller 66 is provided for the apparatus 10. The main controller 66 includes one or more processors capable of executing ladder logic, programmed instructions, or some combination thereof. For example, it may be a general-purpose microcomputer of a known type, such as a PC-based computer, or may be a custom processor, or may incorporate one or more programmable logic controllers (PLC). The main controller 66 is operably connected to the individual functional components of the apparatus 10 as well as the sensors described above in order to receive data and/or transmit commands to each sensor or component. The main controller 66 may include user controls 67 such as a touch screen, keypad, or switches.

The apparatus 10 includes a power supply subassembly 68 operable to provide electrical power of the appropriate type (i.e. AC/DC), voltage, frequency, and current capacity as required by the main controller 66 and other working components of the apparatus 10. To provide maximum portability, the power supply subassembly 68 may incorporate a storage device such as a battery. In the illustrated example, the power supply subassembly 68 includes a rechargeable battery 70, for example a 12 V battery, a charger 72 operable to receive external electrical power such as mains AC current and charge the battery 70, and a DC to DC voltage converter 74 operable to produce DC current at various voltages.

A first motor controller 76 is connected to the first pump 30. The first motor controller 76 has power connections to the power supply subassembly 68 and control connections to the main controller 66. The first motor controller 76 is operable to receive commands from the main controller 66 and in response, provide electrical power of the appropriate type (i.e. AC/DC), voltage, frequency, and current capacity to drive the first pump 30 in the commanded speed and direction.

A second motor controller 78 is connected to the second pump 34. The second motor controller 78 has power connections to the power supply subassembly 68 and control connections to the main controller 66. The second motor controller 78 is operable to receive commands from the main controller 66 and in response, provide electrical power of the appropriate type (i.e. AC/DC), voltage, frequency, and current capacity to drive the second pump 34 in the commanded speed and direction.

A third motor controller 100 is connected to the circulation pump 84. The third motor controller 100 has power connections to the power supply subassembly 68 and control connections to the main controller 66. The third motor controller 100 is operable to receive commands from the main controller 66 and in response, provide electrical power of the appropriate type (i.e. AC/DC), voltage, frequency, and current capacity to drive the circulation pump 84 in the commanded speed and direction.

A fourth motor controller 102 is connected to the replenishment pump 86. The fourth motor controller 102 has power connections to the power supply subassembly 68 and control connections to the main controller 66. The fourth motor controller 102 is operable to receive commands from the main controller 66 and in response, provide electrical power of the appropriate type (i.e. AC/DC), voltage, frequency, and current capacity to drive the replenishment pump 86 in the commanded speed and direction.

The main controller 66 may communicate directly with the functional components of the apparatus 10, or through intermediate devices if required.

The data connections between the main controller 66 and the individual components may be through wired or wireless channels.

The main controller 66 may be used for feedback control of the components in the apparatus 10 based on one or more sensor inputs.

The apparatus 10 may include means for communication with outside devices, for the purpose of exporting data. Communication may be wired or wireless. In the illustrated example, the communication function is provided by a cellular modem 79 connected to the main controller 66.

Optionally, the apparatus 10 may incorporate a dialysis circuit, labeled 80 generally. The dialysis circuit 80 includes a dialysis filter (also referred to as a dialyzer) 82, a circulation pump 84, a replenishment pump 86, a dialysate reservoir 88, a waste reservoir 90, and several check valves.

The dialysis filter 82 has a primary passage 83 and a secondary passage 85. Internal to the dialysis filter 82, the primary and secondary passages 83, 85 are separated by a semi-permeable membrane having a filtration cutoff suitable for the intended application. Suitable dialysis filters are commercially available.

In the illustrated example, the dialysis circuit 80 includes a first flowpath defined from a bleed point 81 in one of the fluid loops 26, 32, through the circulation pump 84, through the primary passage 83 of the dialysis filter 82, and to the perfusate reservoir 20 of the organ chamber 12. In this particular configuration, a bleed point 81 for the first flowpath is positioned between the outlet connection 22 and the oxygenator 82. It will be understood that the bleed point 81 could be located at any point in the first or second fluid loops 26, 32.

In the illustrated example, the dialysis circuit 80 includes a second flowpath defined from the dialysate reservoir 88, through the replenishment pump 86, and to the perfusate reservoir 20 of the organ chamber 12. A first check valve 92 permits flow out from the dialysate reservoir 88 but not back towards it. A second check valve 94 permits flow out from the replenishment pump 86 towards the perfusate reservoir 20, but not back towards the replenishment pump 86.

In the illustrated example, the dialysis circuit 80 includes a third flowpath defined from the secondary passage 85 of the dialysis filter 82, through the replenishment pump 86, and to the waste reservoir 90. A third check valve 96 permits flow out from the dialysis filter 82 to the replenishment pump 86 but not back towards the dialysis filter 82. A fourth check valve 98 permits flow out from the replenishment pump 86 towards the waste reservoir 90, but not back towards the replenishment pump 86.

The circulation pump 84 and the replenishment pump 86 may be of any type which can provide the required flow rates and pressures of the perfusion and dialysate fluids. In the illustrated example, the pumps 84, 86 are peristaltic pumps (also commonly referred to as roller pumps), each being driven by its own electric motor.

The dialysate reservoir 88 is loaded with a dialysate (also referred to as a buffer fluid) of a predetermined composition.

In operation, the circulation pump 84 provides a constant flow of perfusate through the primary passage 83 of the dialysis filter 82.

The replenishment pump 86 has two different functions. In a forward direction, referred to as “push operation”, it causes dialysate fluid to flow from the dialysate reservoir 88 to the perfusate reservoir 20 of the organ chamber 12. This dialysate fluid mixes with the perfusate fluid F; the mixed fluids flow through the primary passage 83 of the dialysis filter 82, moved by the operation of the circulation pump 84.

In a reverse direction, referred to as “pull operation”, the replenishment pump 86 extracts fluid from the secondary passage 85 of the dialysis filter 82 and pumps it to the waste reservoir 90.

In alternative embodiments, the push-pull operations may be eliminated and the replenishment pump 86 may be used to produce a countercurrent flow.

An example of the operation of the apparatus 10 is as follows.

An organ O to be perfused is placed on the sling 14 within the organ chamber 12. The first and optional second inlet connections 16, 18 are made, as well as the outlet connection 22. The sling 14, for example, could be fabricated from silicone or similar material. The sling 14 may be tailored to meet the requirements of specific organs.

The fluid loops 26, 32 are loaded with perfusion fluid F. If the second fluid loop 32 is to be used, the shutoff valves 36 are opened. If it is not to be used, they remain closed.

The perfusion cycle is initiated through the user controls 67. The main controller 66 opens the oxygen flow valve 40.

The main controller 66 commands the first and second pumps 30, 34 to operate.

The first and second syringe drivers 44, 50 are operated as required to introduce additives into the first and/or second fluid loops 26, 32. For example, the syringe drivers 44, 50 may each have independent user controls for setting the quantity, rate, and/or timing of additive delivery.

The main controller 66 receives data from the various sensors and operates the components of the apparatus 10 in accordance with its programming to perfuse the organ O and maintain the organ O in a desired condition. It may simultaneously execute one or more closed loop feedback control processes. It is noted that the apparatus 10 is suitable for sub-normothermic operation, that is, the organ O and perfusion fluid F may be at a temperature lower than normal body temperature. For example, it may operate at typical indoor room temperatures, not exceeding approximately 25 degrees C.

One possible feedback loop includes varying the pump speed of the first pump 30 to maintain a predetermined pressure or pressure range in the perfusion fluid F, as sensed by the first pressure sensor 56.

Another possible feedback loop includes varying the pump speed of the second pump 34 to maintain a predetermined pressure or pressure range in the perfusion fluid F, as sensed by the second pressure sensor 60.

In implementing pressure feedback, it is noted that, for a given flow resistance, the pressure will be proportional to the flow rate, which in turn is proportional to pump speed. The first and second flowrate sensors 54 and 58 can be used to sense a flowrate which can be used to compute system fluid resistance.

Another possible feedback loop includes varying the flow rate of oxygen to the oxygenator 28 to maintain a predetermined partial pressure of carbon dioxide in the perfusion fluid F, or a predetermined partial pressure of oxygen, as sensed by the oxygen sensor 62, the carbon dioxide sensor 64, or a combination thereof. The oxygen flow rate may be modulated using the oxygen flow valve, which may be an on/off or proportional type valve.

The dialysis circuit 80 may be operated separately from the first and second fluid loops 26, 32 or at the same time. The dialysis circuit 80 is useful for maintaining a steady state concentration for one or more perfusate ingredients e.g., potassium, or some other characteristic ingredient or by-product.

The replenishment pump flow directions are controlled by the main controller 66 and the operational direction of the replenishment pump 86.

The dialysis function can be controlled manually or automatically. For example, the operator may use the user controls 67 to specify programmed intervals of time for “push” and “pull” operation of the replenishment pump 86.

The foregoing has described apparatus for organ perfusion and methods for its operation. All of the features disclosed in this specification, and/or all of the steps of any method or process so disclosed, may be combined in any combination, except combinations where at least some of such features and/or steps are mutually exclusive.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends, or to any novel one, or any novel combination, of the steps of any method or process so disclosed.

What is claimed is:

1. An apparatus for perfusing an organ, comprising:
an organ chamber configured to provide physical protection to an organ;
at least one fluid flow loop from an outlet connection of the organ chamber, through an oxygenator, through a pump, and to an inlet connection of the organ chamber; and
a dialysis circuit, including a dialysis filter, a circulation pump, a replenishment pump, a dialysate reservoir, and a waste reservoir, wherein the dialysis circuit includes:
a first flowpath defined from a bleed point in the at least one fluid flow loop, through the circulation pump, through the dialysis filter, and to the perfusate reservoir of the organ chamber;
a second flowpath defined from the dialysate reservoir, through the replenishment pump, and to the perfusate reservoir of the organ chamber; and
a third flowpath defined from the dialysis filter, through the replenishment pump, and to the waste reservoir; and
a container enclosing the components of the apparatus, wherein the apparatus is portable.

2. The apparatus of claim 1 wherein the apparatus has a weight of 32 kg or less.

3. The apparatus of claim 1 wherein the container has a volume of 80 liters or less.

4. The apparatus of claim 1 wherein the organ chamber is provided internally with a flexible mesh sling configured to support the organ above an operating level of perfusion fluid in the organ chamber.

5. The apparatus of claim 1, wherein all fluid-contacting elements of the at least one fluid flow loop are defined by a tubing set configured to be removed from the apparatus without having to sterilize the apparatus.

6. The apparatus of claim 1, wherein the at least one fluid flow loop is configured for operation with the organ and perfusion fluid at a temperature not exceeding approximately 25 degrees C.
